(19) United States
(12) Patent Application Publication
(10) Pub. No.: US 2026/0205167 A1
(43) Pub. Date: Jul. 16, 2026

(54) BEAMFORMING SOLUTION FOR MIMO COMMUNICATION

(71) Applicant: Nokia Solutions (Shanghai) Co., Ltd., Shanghai (CN)

(72) Inventors: Nuan Song, Shanghai (CN); Tao Yang, Shanghai (CN)

(73) Assignee: Nokia Solutions (Shanghai) Co., Ltd., Shanghai (CN)

(21) Appl. No.: 19/099,566

(22) PCT Filed: Jul. 29, 2022
(86) PCT No.: PCT/CN2022/109173

§ 371 Date: Jan. 29, 2025

(51) Int. Cl. H04B 7/0426

(52) U.S. Cl. CPC H04B 7/0426

(57) ABSTRACT

Example embodiments of the present disclosure relate to on-demand labelling for channel classification training. A first device transmits a first signal from the first device to each of a plurality of second devices via a first beam. The first also updates the first beam at least once by: receiving, from each of the plurality of second devices, a second signal transmitted via a second beam which is determined based on the first beam; and adjusting the first beam based on a measurement result of the received second signals. In this way, instead of achieving the maximum beamforming gain with respect to a one-to-one network device and terminal device pair, the total beamforming gain among multiple network devices and multiple terminal devices is optimized.

### FIELD

Embodiments of the present disclosure generally relate to the field of telecommunication and in particular, to a beamforming solution for a multiple input multiple output (MIMO) system.

### BACKGROUND

In order to meet the increasing wireless data traffic demand, a plurality of schemes have been proposed and implemented, where the MIMO technology is considered as one powerful scheme to achieve high data throughputs in the communication system. MIMO refers to the type of wireless transmission and reception scheme where both a transmitter and a receiver employ more than one antenna. Further, in the MIMO system, before communicating with the network device, the terminal device needs procedures of analog beamforming and beam alignment. Thus, technologies of beamforming and beam alignment are important for the MIMO system.

### SUMMARY

In a first aspect of the present disclosure, there is provided a first device. The first device comprises at least one processor; and at least one memory storing instructions that, when executed by the at least one processor, cause the first device at least to perform: transmitting a first signal from the first device to each of a plurality of second devices via a first beam; updating the first beam at least once by: receiving, from each of the plurality of second devices, a second signal transmitted via a second beam which is determined based on the first beam; and adjusting the first beam based on a measurement result of the received second signals.

In a second aspect of the present disclosure, there is provided a second device. The second device comprises at least one processor; and at least one memory storing instructions that, when executed by the at least one processor, cause the second device at least to perform: determining a second beam be used by the second device to communicate with first devices at least once by: receiving, from each of a plurality of first devices, a first signal transmitted via a first beam determine by respective first device; adjusting, the second beam based on a measurement result of the received first signals; and transmitting, via the second beam, a second signal to the first devices.

In a third aspect of the present disclosure, there is provided a third device. The third device comprises at least one processor; and at least one memory storing instructions that, when executed by the at least one processor, cause the third device at least to perform: generating a configuration related to at least one of the following: a first signal transmitted by first devices which are initiators of a beam alignment, or a second signal transmitted by second devices which are coordinators of a beam alignment; and transmitting, the configuration to one of the first and second device that is a network device connecting to the third device.

In a fourth aspect of the present disclosure, there is provided a method. The method comprises: transmitting, at a first device, a first signal from the first device to each of a plurality of second devices via a first beam; updating the first beam at least once by: receiving, from each of the plurality of second devices, a second signal transmitted via a second beam which is determined based on the first beam; and adjusting the first beam based on a measurement result of the received second signals.

In a fifth aspect of the present disclosure, there is provided a method. The method comprises: determining at a second device a second beam be used by the second device to communicate with first devices at least once by: receiving, from each of a plurality of first devices, a first signal transmitted via a first beam determine by respective first device; adjusting, the second beam based on a measurement result of the received first signals; and transmitting, via the second beam, a second signal to the first devices.

In a sixth aspect of the present disclosure, there is provided a method. The method comprises: generating, at a third device, a configuration related to at least one of the following: a first signal transmitted by first devices which are initiators of a beam alignment, or a second signal transmitted by second devices which are coordinators of a beam alignment; and transmitting, the configuration to one of the first and second device that is a network device connecting to the third device.

In a seventh aspect of the present disclosure, there is provided a first apparatus. The first apparatus comprises: means for transmitting, a first signal to each of a plurality of second apparatuses via a first beam; means for updating the first beam at least once by: receiving, from each of the plurality of second apparatuses, a second signal transmitted via a second beam which is determined based on the first beam; and adjusting the first beam based on a measurement result of the received second signals.

In an eighth aspect of the present disclosure, there is provided a second apparatus. The second apparatus comprises: means for determining, at a second apparatus, a second beam be used by the second apparatus to communicate with first apparatuses at least once by: receiving, from each of a plurality of first apparatuses, a first signal transmitted via a first beam determine by respective first apparatus; adjusting, the second beam based on a measurement result of the received first signals; and means for transmitting, via the second beam, a second signal to the first apparatuses.

In a ninth aspect of the present disclosure, there is provided a third apparatus. The third apparatus comprises: means for generating, at a third apparatus a configuration related to at least one of the following: a first signal transmitted by first apparatuses which are initiators of a beam alignment, or a second signal transmitted by second apparatuses which are coordinators of a beam alignment; and means for transmitting, the configuration to one of the first and second apparatus that is a network apparatus connecting to the third apparatus.

In a tenth aspect of the present disclosure, there is provided a computer readable medium. The computer readable medium comprises instructions stored thereon for causing an apparatus to perform at least the method according to the first aspect.

In an eleventh aspect of the present disclosure, there is provided a computer readable medium. The computer readable medium comprises instructions stored thereon for causing an apparatus to perform at least the method according to the second aspect.

In a twelfth aspect of the present disclosure, there is provided a computer readable medium. The computer readable medium comprises instructions stored thereon for causing an apparatus to perform at least the method according to the third aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for communication according to some example embodiments of the present disclosure;

FIG. 3A illustrates another signaling flow for communication according to some example embodiments of the present disclosure;

FIG. 3B illustrates a transmission timing according to some example embodiments of the present disclosure;

FIG. 4A illustrates a further signaling flow for communication according to some example embodiments of the present disclosure;

FIG. 4B illustrates another transmission timing according to some example embodiments of the present disclosure;

FIG. 5 illustrates examples of the access point (AP) and terminal device distribution within the considered area

FIG. 6A illustrates a spectral efficiency performance of the proposed analog beam alignment procedure as compared to a small cell scheme;

FIG. 6B illustrates another spectral efficiency performance of the proposed analog beam alignment procedure as compared to a small cell scheme;

FIG. 7 illustrates convergence performance of the proposed beam alignment procedure versus the number of iterations;

FIG. 8 illustrates a flowchart of a method implemented at a first device according to some example embodiments of the present disclosure;

FIG. 9 illustrates a flowchart of a method implemented at a second device according to some example embodiments of the present disclosure;

FIG. 10 illustrates a flowchart of a method implemented at a third device according to some example embodiments of the present disclosure;

FIG. 11 illustrates a simplified block diagram of an apparatus that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IOT device or fixed IOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

The mmWave/Tera Hertz communications are expected to be supported such that more communication resources may be available for wireless communication. However, the mmWave/THz communications always have coverage issues, due to propagation limitations, such as, large pathloss, easy blockage, as well as shadowing. A network architecture referred to as distributed/cell-free MIMO network is discussed by working groups of massive MIMO and THz of international mobile telecommunication (IMT)-2030 (the sixth generation, 6G). Instead of using a single and co-located extreme large antenna array, in the distributed/cell-free MIMO network, multiple large arrays with a smaller dimension in a hybrid architecture can be efficiently deployed over multiple access points (APs) in a distributed way, by exploring the marco-diversity from distributed APs.

As for cellular/small cell case, the beam management procedure aims to achieve the maximum beamforming gain. In some cases, each terminal device carries out the beam alignment procedure individually with its serving network device (such as, a gNB). In summary, in single-cell MIMO system, the beam management aims at the best beams between gNB to each terminal device, which is achieved by transmitting beam sweeping and terminal device's feedback on a beam selection to acquire the best beam for the terminal device.

It is expected that the distributed/cell-free MIMO network may support communications on mmWave and sub-Thz freq. Specifically, at mmWave and sub-Thz frequencies, the terminal device will be mounted with multiple antennas and hybrid array architectures, which requires analog beamforming at terminal device and beam alignment with the network devices (such as, APs). Thus, in distributed/cell-free MIMO, how to design distributed analog beamforming at each AP is desired so that the beam alignment between coordinated APs and the corresponding serving UEs can be effectively carried out.

However, in the distributed or cell-free MIMO network, where multiple APs simultaneously serve multiple terminal devices, the goal of the beamforming is to maximize the total beamforming gain, where the maximum total beamforming gain cannot be achieved when each terminal device aligns analog beams with each AP.

If the legacy beam alignment procedure is applied in the distributed or cell-free MIMO network, APs carry out beam sweeping (cell-specific), and each terminal device will feedback a number of beam identifies (IDs) for its serving APs. In this event, the number of beams scales with the number of simultaneously serving UEs at each AP, which is not practical since it either requires sufficient number of Radio frequency (RF) chains at each AP to support all its serving terminal devices, or the beams are not commonly optimized to achieve the total beamforming gain. Furthermore, terminal device also needs to determine its receive analog beam(s) from the channels of the combined serving APs instead of each individual AP, which is also a pending technical point.

In view of the above, it is desirable to propose an efficient beam alignment mechanism for the distributed/cell-free MIMO systems, where the analog beamforming requirements of the terminal device equipped with multi-antenna and hybrid-array may be meet.

According to the present discourse, a beamforming solution for MIMO system is provided. In the present discourse, each of a plurality of first devices transmits a respective first signal to a plurality of second devices via respective first beam, each of the plurality of second devices measures the first signals to determine respective second beam. Then, each of the plurality of second device transmits a respective second signal to the plurality of first devices via the determined second beam. Then, each of the plurality of the first devices updates respective first beam based on the received second signals. In this way, instead of achieving the maximum beamforming gain with respect to a one-to-one network device and terminal device pair, the total beamforming gain among multiple network devices and multiple terminal devices is optimized.

For ease of discussion, some terms used in the following description are listed as below:
First device: an initiator during a beam alignment; the first device triggers the beam alignment.
First beam: one or more beams used or to be used by the first device.
First signal: a signal transmitted by the first device. The first signal may be distributed in different transmission resources.
Second device: a coordinator during a beam alignment.
Second beam: one or more beams used or to be used by the second device.
Second signal: a signal transmitted by the second device. The second signal may be distributed in different transmission resources.

### Example Environment

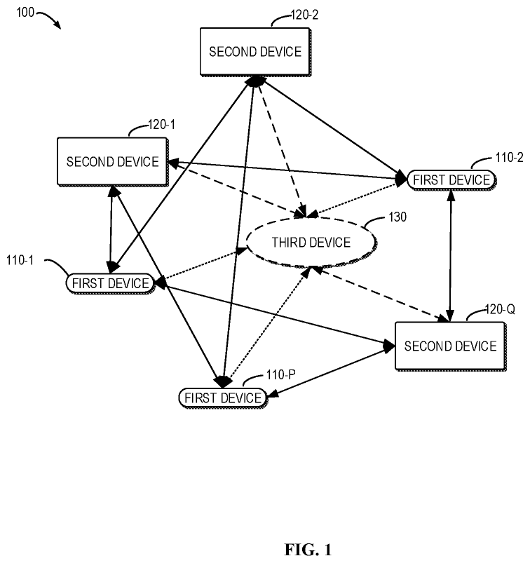

FIG. 1 illustrates an example communication environment 100 in which example embodiments of the present disclosure can be implemented. In the communication environment 100, a plurality of communication devices are involved, including a plurality of first devices 110-1, 110-2, . . . , 110-P and a plurality of second devices 120-1, 120-1, . . . , 120-Q, where both of P and Q are larger than 2. For the purpose of discussion, the first devices 110-1, 110-2, . . . , 110-P are collectively or individually referred to as first devices 110, and the second devices 120-1, 120-1, . . . , 120-Q are collectively or individually referred to as second devices 120.

In the specific embodiments, each first device 110 may communicate with more than one second device 120 via physical communication channels or links, and each second device 120 may communicate with more than one first device 110 via physical communication channels or links accordingly. It is to be clarified that different first devices 110 may communicate with a plurality of different second devices 120, and different second devices also may communicate with a plurality of different first devices 110 similarly.

Further, the technology of distributed/cell-free MIMO is supported. Specifically, each first device 110 may communicate with the more than one second device 120 via one or more first beams to enable a directional communication, and each second device 120 also may communicate with the more than one first devices 110 via one or more second beams to enable a directional communication.

Optionally, the communication environment 100 also comprises a third device 130 which in charge of the resource scheduling and network management. As one specific embodiment, the third device is central processing device (such as, central processing unit, CPU). As another specific embodiment, the third device may be a core network (CN) device.

In some example embodiments, the first device 110 are network devices (such as, APs) the first devices 110 are connected to the third device 130. In this event, the third device 130 may transmit configuration and information to the first devices 110, and the first devices 110 may optionally forward the received configuration and information to the second devices 120 (such as, terminal devices). Alternatively, in some example embodiments, the second device 120 are network devices (such as, APs), the second devices 120 are connected to the third device 130. In this event, the third device 130 may transmit configuration and information to the second devices 120 and the second devices 120 may optionally forward the received configuration and information to the first devices 110 (such as, terminal devices).

It is to be understood that the number of devices and their connections shown in FIG. 1 are only for the purpose of illustration without suggesting any limitation. The communication environment 100 may include any suitable number of devices adapted for implementing embodiments of the present disclosure. For example, the numbers and their connections of first devices 110, second devices 120 and the third device 130 are only for the purpose of illustration without suggesting any limitations. The communication environment 100 may include any suitable first devices 110, second devices 120 and the third device 130 adapted for implementing embodiments of the present disclosure. Further, although not shown, it is to be understood that one or more additional first devices, second devices and third devices may be located in the respective cells.

### Work Principle and Example Signaling Flow

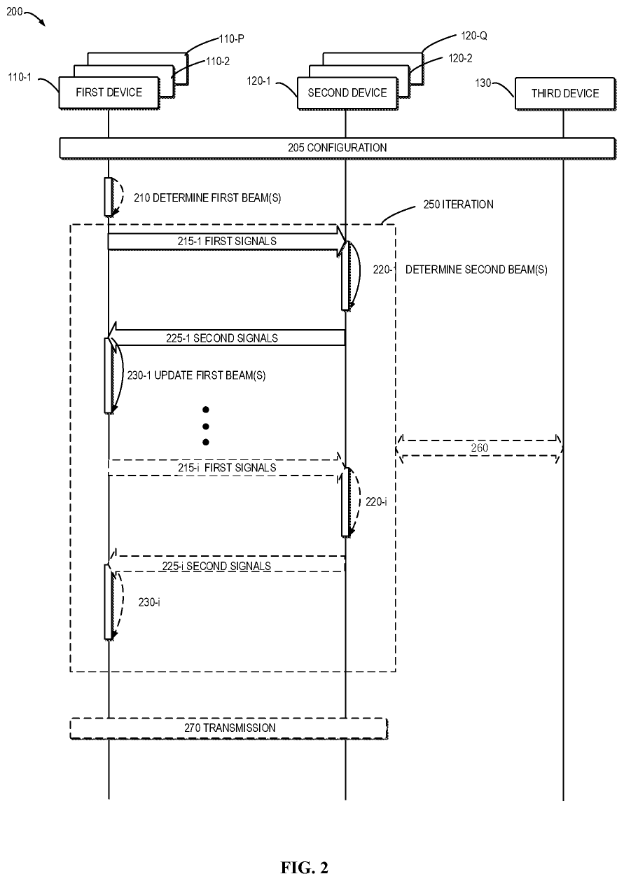

Example embodiments of the present disclosure will be described in detail below with reference to FIG. 2, which shows a signaling flow 200 for communication according to some example embodiments of the present disclosure. For the purpose of discussion, the signaling flow 200 will be described with reference to FIG. 1.

As shown in FIG. 2, the signaling flow 200 involves first devices 110 (from first device 110-1 to first device 110-P), second devices 120 (from second device 120-1 to second device 110-Q) and a third device 130. For the purpose of discussion, reference is made to FIG. 1 to describe the signaling flow 200.

In the following text, although descriptions are discussed with regard to one specific first device 110 (such as, first device 110-1) and one specific second device 120 (such as, second device 120-1) sometimes, it would be appreciated that all the first devices 110/second device 120 are analogues. That is, the descriptions discussed with regards to one specific first device 110 should be considered to be adaptable to other first device(s) 110, and the descriptions discussed with regards to one specific second device 120 should be considered to be adaptable to other second device(s) 120. Merely for brevity, some similar contents are omitted here.

It is also to be clarified that in the following descriptions, different first devices 110 may communicates with different a plurality of second device 120, and different second also may communicate with different a plurality of first devices 110.

In some example embodiments, the first devices 110 are network devices, the second devices 120 are terminal devices, and the third device 130 is a central processing device.

Alternatively, in some example embodiments, the first devices 110 are terminal devices, the second devices 120 are network devices, and the third device 130 is a central processing device.

In operation, the first device 110-1 transmits 215 a first signal to the second devices 120 via a first beam. In some example embodiments, the first device 110-1 transmits the first signal in broadcast or multicast manner.

Additionally, each of the other first devices 110-1 to 110-P also transmits 215 respective first signal to the second devices 120 via respective first beam.

In some example embodiments, the first beam may be initially determined 210 by respective first device based on any suitable manner. In one specific example embodiment, the first beam is initially determined as a predetermined beam, such as, the latest used beam, the most frequently used beam, a beam with a simple beamforming matrix. It is to be understood that the above examples of predetermined beam are only for the purpose of illustration without suggesting any limitations. In other example embodiments, the first beam is initially determined as any other suitable pre-determined beams. The present disclosure is not limited in this regard.

Alternatively, in another specific example embodiment, the first beam is initially determined as a randomly obtained beam. For example, a random beam selection mechanism (such as, a random DFT based beam) may be used for initially determining the first beam. It is to be understood that in other example embodiments, other random beam selection mechanism also may be used for initially determining the first beam. The present disclosure is not limited in this regard.

In some example embodiments, the first signals are reference signals/pilots, such as channel state information (CSI)-reference signal (RS), CSI-RS, and sounding reference signal, SRS.

In some example embodiments, the first beam is initially determined as a wide beam. In this way, the first signals transmitted via the first beam may be detected more easily by the second devices 120.

Based on the first signals, each second device 120 may determine 220-1 respective second beam which is used by the second device 120 for communicating with its related first devices 110.

As shown in FIG. 2, the second device 120-1 receives first signals from each of the first devices 110 and adjusts a respective second beam based on a measurement result of the received first signals.

In this way, a second beam to be used by the second device may be determined without any feedback needed from the second device 120-1 to the first devices 110.

In some example embodiments, the second device 120-1 adjusts the second beam to increase a beamforming gain at the second device 120 with respect to all its related first devices 110. In one specific example embodiment, the second device 120-1 receives the first signals by beam sweeping, and determines which beam has a higher beamformer gain than at least one other beam. Based on the result of beam sweeping, the second beam may be determined. Additionally, in some example embodiments, the second device 120-1 adjusts the second beam to a beam that enables a maximum beamforming gain at the second device 120-1 with respect to all its related first devices 110.

In this way, as the second beam is determined based on the first signals from a plurality of first devices 110, a total beamforming gain at a system level is maximized.

In some example embodiments, the first signals are transmitted by the first devices 110 simultaneously. In this way, each second device 120 may receive all signals needed to be measured at one time, which saves the power consumption of the second device and improve the network performance accordingly.

In some example embodiments the first signal is periodical. In this way, each second device 120 may select improper occasion(s) to receive the first signals, which enables a more flexible receipt of the first signals.

In some example embodiments, the first device 110 may update 230-1 the originally determined first beam, which may be achieved by measuring second signals transmitted by the second devices 120. As shown in the FIG. 2, the first device 110-1 receives 225-1 a second signal from each of its related second device 120 and adjusts the first beam based on a measurement result of the received second signals.

Similar with the operations of determining the second beam at the second device 120, in some example embodiments, the first device 110-1 adjusts the first beam to increase a beamforming gain at the first device 110-1 with respect to all its related second devices 120. In one specific example embodiment, the first device 110-1 receives the second signals by beam sweeping, and determines which beam has a higher beamforming gain than at least one other beam. Based on the result of beam sweeping, the first beam may be updated. Additionally, in some example embodiments, the first device 110-1 adjusts the first beam to a beam that enables a maximum beamforming gain at the first device 110-1 with respect to all its related second devices 120.

In this way, as the first beam is updated based on the second signals from a plurality of second devices 120, a total beamforming gain at a system level is maximized.

In some example embodiments, the second signals are transmitted by the second devices 120 simultaneously. In this way, each first device 110 may receive all signals needed to be measured at one time, which saves the power consumption of the first device and improve the network performance accordingly.

Similar with the first signals, the second signal also may be reference signals/pilots, such as downlink (DL) CSI-RS, uplink (UL) SRS. Additionally, in some example embodiments, the second signal is periodical. In this way, each first device 110 may select improper occasion(s) to receive the second signals, which enables a more flexible receipt of the second signals.

In some example embodiments, the transmission of either the first signals or the second signals may be configured by the third device 130. The third device 130 may configure any suitable parameter for the transmission of either the first signals or the second signals. One example of the suitable parameter is a transmission resource, such as, first transmission resources allocated for the first signals, and second transmission resources allocated for the second signals. Another example of the suitable parameter is a timing for transmission, such as, a first timing configured for the first signals, and a second timing configured for the second signals. A further example of the suitable parameter is a periodicity for transmission, such as, a first periodicity for transmitting the first signals, and a second periodicity for transmitting the second signals. Other examples of the suitable parameter, include but are not limited to, an indication for transmission, such as, a first indication that indicate the first devices 110 to transmit the first signals, a second indication that indicate the second devices 120 to receive the first signals.

It is to be understood that the above examples of the suitable parameter are only for the purpose of illustration without suggesting any limitations. In some other example embodiments, any suitable parameter may be determined by the third device 130 for the transmission of either the first signals or the second signals. The present disclosure is not limited in this regard.

Additionally, the configuration may be indicated to the first devices 110 and the second devices 120. Specifically, in some example embodiments, the first devices 110 are network devices and connected to the third device 130. In this event, the third device 130 may transmit the configuration to the first devices 110 and the first devices 110 may further forward the received configuration to the second devices 120. Alternatively, in some example embodiments, the second devices 120 are network devices and connected to the third device 130. In this event, the third device 130 may transmit the configuration to the second devices 120 and the second devices 120 may optionally forward the received configuration to the first devices 110.

In this way, the simultaneous transmission of either the first signals or the second signals is ensured.

In some example embodiments, in order to refine the first/second beam. An iteration 250 may be performed. During the iteration 250, the operation of determining the second beam may be performed 220-i by the second device 120 more than once. As shown in FIG. 2, the second device 120 receives 215-i first signals from each of the first devices 110 and adjusts the respective second beam based on a measurement result of the received first signals.

Accordingly, during the iteration 250, the operation of updating the first beam may be performed 230-i by the first device 110 more than once. As shown in FIG. 2, the first device 110 receives 225-i second signals from each of the second devices 120 and adjusts the respective first beam based on a measurement result of the received second signals.

In some example embodiments, the first device 110 iteratively updating the first beam until a first cease condition is met. Many factors may be used by the first cease condition to control the iteration 250. One example factor is the number of iterations. Another example factor is a beamforming gain of the first beam at the first device. A further example factor is a beamforming gain difference between two adjacent iterations. Other example factors, include but are not limited to, an indication (such as, an indication transmitted by the third device 130) to cease iteration.

In one specific example embodiments, the first termination condition is determined to be met if the number of iterations reaches a first pre-defined number. Alternatively, in another specific example embodiments, the first termination condition is determined to be met if a beamforming gain brought by the at least one first beam at the first device is equal to or larger than a first pre-defined beamforming gain. Alternatively, in another specific example embodiments, the first termination condition is determined to be met if a beamforming gain difference between two adjacent iterations is equal to or smaller than a first pre-defined gain difference. Alternatively, in another specific example embodiments, the first termination condition is determined to be met if a third indication that indicates the first device to terminate the iterating is received.

It is to be understood that the above example factors are only for the purpose of illustration without suggesting any limitations. In the other example embodiments, any suitable deterministic configuration parameters and dynamic measurements at the first and second device may be associated with the first cease condition.

Similarly, in some example embodiments, the second device 120 iteratively determining the second beam until a second cease condition is met. Similar with the first cease condition, the second cease condition also may be related with one or more of the number of iterations, the beamforming gain of the second beam at the second device, a beamforming gain difference between two adjacent iterations or an indication (such as, an indication transmitted by the third device 130) to cease iteration. Merely for brevity, the similar contents are omitted here.

In some example embodiments, the first devices 110 and the second devices 120 share a common cease condition, which means that the first and second cease conditions are the same. Alternatively, the first and second cease conditions are defined independently, which means that the first and second cease conditions may be different.

In some example embodiments, the first and second cease conditions are default configurations. In this event, the first and second cease conditions may be implemented to be local configuration at the first and second devices. Thus, no extra signaling exchanging is needed from the third device 130.

Alternatively, the first and second cease conditions are determined by the third device 130 and informed to the first devices 110 and the second devices 120. The transmission procedure of the first and second cease conditions is similar with that of the configuration of the first and second signals. Merely for brevity, the similar contents are omitted here.

In some example embodiments, whether to cease the iteration 250 is determined by the first device 110/second device 120 according to the first/second cease condition. Alternatively, whether to cease the iteration 250 is determined by the third device 130. As illustrated in FIG. 2, the first device 110/second device 120 may transfer measurement results of the second/first signals to the third device 130. The third device 130 determines whether to cease the iteration 250 based on the measurement results and/or the first/second cease condition. If the third device 130 determines to cease the iteration 250, the third device 130 may generate an indication to instruct the first device 110/second device 120 to cease the iteration 250.

In some example embodiments, the status of iteration 250 should be consistent among the first devices 110, the second device 120 and the third device 130. Thus, once the iteration 250 is determined to be started or ceased, the first devices 110, the second device 120 and the third device 130 should exchange messages with each other to ensure the status of iteration 250 consistent.

As discussed above, the first device 110-1 or the second device 120-1 revives the second signals and the first signals by beam sweeping. In some example embodiments, the beam sweeping procedure may be optimized during the iteration 250. Specifically, the number of beams in the beam sweeping decreases as the number of iterations increases. That is because after the original beam sweeping, the first device 110-1 and the second device 120-1 may possibly understand a general angular coverage, such that the subsequent beam sweeping may be within the general angular coverage. In this way, power consumption caused by unnecessary beam sweeping is avoided.

Next, the first device 110 and the second device 120 may perform 270 transmission with each other (including data, RS and so on).

According to the above example processes, a beam alignment mechanism in the distributed/cell-free MIMO is enabled. According to some example embodiments of the present disclosure, the maximization of the total effective array gain between the first devices 110 and the second devices 120 is achieved, approaching the fully digital performance.

In addition, the present discourse does not have to increase the number of RF chains, which is more simple, convenient and implementable.

Further, the beam alignment may be triggered periodically in communicate system. In this way, even the channel condition changes and the terminal device moves, the total beamforming gain also may be ensured.

Discussions with Regard to One Specific Scenario

In order to better understand the solution of the present disclosure, example processes will be discussed with regard to one specific scenario. In the specific scenario, the cell-free MIMO network is supported, and the cell-free MIMO network includes M APs and K terminal devices, where M and K are larger than 2.

The M APs are indexed to be AP 1, . . . . AP m, . . . . AP M (m is an index of the AP and m=1, . . . , M) and the K terminal devices are indexed to be terminal device 1, . . . terminal device k, . . . terminal device K (k is an index of the terminal device k=1, . . . , K), respectively.

For the purpose of discussion, the AP 1, . . . . AP m, . . . . AP M are collectively or individually referred to as AP, and the terminal device 1, . . . terminal device k, . . . terminal device K are collectively or individually referred to as terminal device.

Distributed analog beamforming are carried out at each AP. For AP m and terminal devoice k, the analog beamforming matrices are denoted by Fₘ and Wₖ, respectively.

In some example embodiments, to achieve a good beam alignment, the beamforming procedure may be designed to maximize the total beamforming gain or effective array gain in the cell-free MIMO network. In some example embodiments, the maximization problem can be formulated by below formula (1).

$${max}_{{F}_{m} , {W}_{k}} 𝔼 \{ {‖ {W}^{H} HF ‖}_{F}^{2} \} , \qquad ( 1 )$$

Where S.t. |Fₘ(i, j)|=1, |Wₖ(i, j)|=1 ∀m, ∀k,
parameterH is the total channel matrix from M APs to K terminal devices,
parameter F=diag{F₁, . . . , F_{M}} and W=diag{W₁, . . . , W_{K}} are total beamforming matrices at APs and terminal devices, respectively,
the operation ∥⋅∥_{F} denotes the Frobenius norm. The phase shifter based energy-efficient beamforming network is assumed with constant modulus constraint.

In some example embodiments, to solve the above maximization problem, it is efficient to carry out alternating calculations of analog beamformers and combiners between APs and terminal devices in a coordinated manner.

In some example embodiments, with a fixed Fₘ, ∀m, each terminal device needs to determine the best beamformer Wₖ by solving the following optimization problem formulated by below formula (2).

$${max}_{{W}_{k}} trace ( {W}_{k}^{H} {T}_{k} {W}_{k} ) . \qquad ( 2 )$$

Where

$${T}_{k} = 𝔼 \{ {\sum }_{m = 1}^{M} {H}_{m , k}^{H} {F}_{m}^{H} {F}_{m} {H}_{m , k} \} ,$$

$$s . t . {W}_{k}^{H} {W}_{k} = I ,$$

parameter Tₖ indicates the signal measurements at terminal device k from all APs.

In some example embodiments, with a fixed Wₖ, ∀k, each AP tries to find the best beamformer Fₘ by solving the following optimization problem formulated by below formula (3).

$${max}_{{F}_{m}} trace ( {F}_{m}^{H} {Q}_{m} {F}_{m} ) , \qquad ( 3 )$$

Where

$${Q}_{m} = 𝔼 \{ {H}_{m}^{H} {WW}^{H} {H}_{m} \} ,$$

$$s . t . {F}_{m}^{H} {F}_{m} = I ,$$

where Qₘ indicates the signal measurements at AP m from all K serving terminal devices.

As discussed above, the first deices 110 (i.e., the initiators) may be either the APs or the terminal devices. In the following, the above two cases will be discussed separately.

### Example Scenarios where the Initiators are the APs

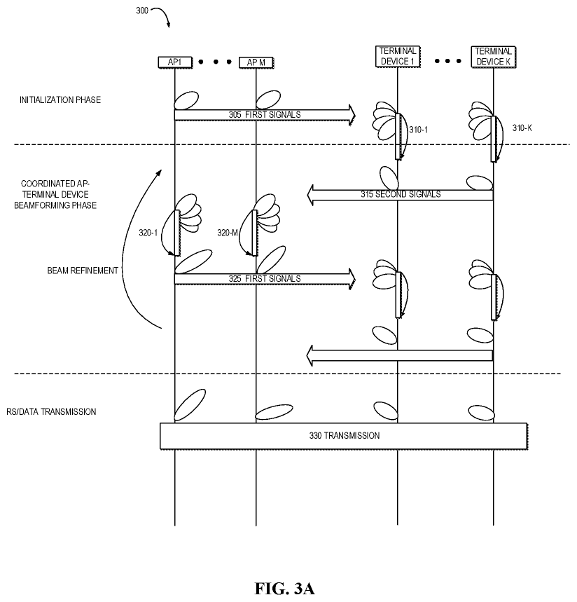

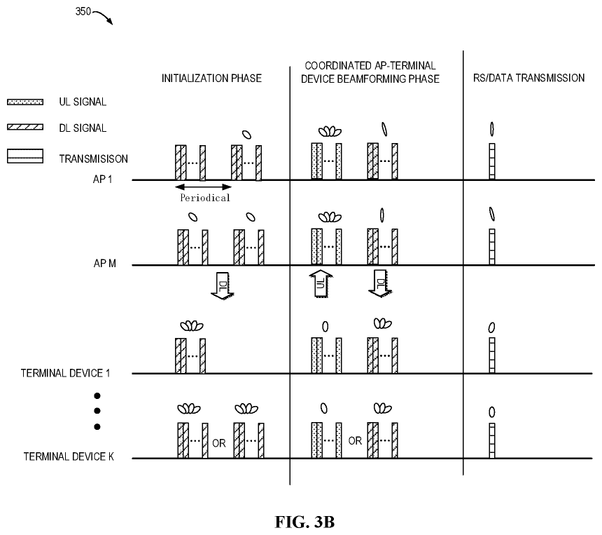

Example embodiments will be described in detail below with reference to FIG. 3A and FIG. 3B, where FIG. 3A shows another signaling flow 300 for communication according to some example embodiments of the present disclosure, and FIG. 3B shows a transmission timing 350 according to some example embodiments of the present disclosure. The signaling flow 300 and transmission timing 350 include AP 1 to AP M and terminal device 1 to terminal device K.

As illustrated in FIG. 3A, during initialization phase, APs (AP 1 to AP M) simultaneously transmit 305 first signals (such as, DL pilot, CSI-RS) via the initialized AP-dedicated common beams m (i.e., the first beam).

In some example embodiments, the simultaneous transmission from the APs is scheduled by a CPU (i.e., the third device). In one specific embodiment, the CPU schedules one or more of transmission resources, a transmit timing, a periodicity of the first signals (such as, CSI-RS).

In some example embodiments, the initialized AP-dedicated common beam(s) is (are) determined at each AP. In one specific example embodiment, the initialized AP-dedicated common beam(s) may be initialized as direct combining, for example,

$${F}_{m} ( 0 ) = {[ {I}_{{N}_{t}}^{T} , {0}_{{M}_{t} - {N}_{t} , {N}_{t}}^{T} ]}^{T} ,$$

where Mₜ, Nₜ denote the numbers of antenna elements and RF chains at each AP, respectively. In some other example embodiments, the initialized AP-dedicated common beam(s) may be determined to be other default beams.

Alternatively, in some example embodiments, the random DFT based beam can be used for initializing the AP-dedicated common beam(s). For DFT initialization beam, Fₘ(0)=C_{DFT}(i)∈C^{M}^{_{T}}^{×N}^{_{T}}, where C_{DFT}(i) is the N_{T} beam vectors randomly selected from the DFT codebook. Additionally, in some example embodiments, if a rough angle of interest can be obtained, the AP-dedicated common beam(s) may be chosen based on this knowledge.

In some example embodiments, in the initialization phase, APs may broadcast the first signals by the initialized first beams (semi-) periodically, such that the terminal device could carry out measuring the received first signals at its dedicated time slot. As shown in FIG. 3B, the terminal device 1 may receive the first signals at the first duration, and the terminal device K may receive the first signals at either the first duration or the second duration. The periodical transmission of the first signals also helps to improve coverage, because the terminal device can apply time average on the measurement of the first signals.

In some example embodiments, the APs will trigger their serving terminal device 1 to terminal device K to apply beam measurements (such as beam sweeping) to receive the first signals sent by the initialized beams from APs. Each of the terminal device 1 to terminal device K determines respective second beam(s), i.e., the terminal device 1 determines 310-1 its respective second beam and the terminal device K determines 310-K its respective second beam accordingly.

In some example embodiments, by using the receive beam measurements, terminal device selects the terminal device-dedicated common beam(s) (i.e., the second beam, represented to be

$${W}_{k}^{( c )} )$$

which is (are) optimal to all its serving APs. In one specific example embodiments, the terminal device-dedicated common beam

$${W}_{k}^{( c )}$$

can be obtained by using beam sweeping to solve the optimization problem in equation (1).

$${W}_{k}^{( c )} = {max}_{{W}_{k} ∈ 𝒲} trace ( {W}_{k}^{H} {T}_{k} {W}_{k} ) \qquad ( 1 )$$

Where [symbol] is the codebook at terminal device and Tₖ is the equivalent channel covariance measurement at terminal device k.

In this way, the selected terminal device-dedicated common beam(s) maximizes the beamforming gain from all its serving APs. As shown in FIG. 3A, terminal devices apply their own common beams and simultaneously transmit 315 UL pilots (such as, SRS) to their serving APs. Then each terminal device transmits 315 the second signals (such as, an UL RS, SRS). In some example embodiments, the CPU also may configure terminal device's upcoming SRS transmission via the APs, such as, transmission resources, a transmit timing and a periodicity.

In some example embodiments, each AP receives and measures the UL pilots, and then selects the AP-dedicated common beam(s) (i.e., an updated first beam) which is (are) optima to all serving terminal devices. In one specific example embodiments, the AP-dedicated common beam

$${F}_{m}^{( c )}$$

can be obtained by using beam sweeping to solve the optimization problem in equation (2).

$${F}_{m}^{( c )} = {max}_{{F}_{m} ∈ ℱ} trace ( {F}_{m}^{H} {Q}_{m} {F}_{m} ) \qquad ( 2 )$$

Where [symbol] is the codebook at AP and Qₘ is the equivalent channel covariance measurement at AP m. Parameter

$${F}_{m}^{( c )}$$

as “common” beam indicates that the AP beams maximize the beamforming gain for all its serving terminal devices.

In some example embodiments, iteration may be used for further aligning the AP-dedicated common beams and terminal device-dedicated common beams. As shown in FIG. 3A, operations at 310-1, 310-K, 315, 320-1, 320-M and 325 may be performed iteratively. In some example embodiments, the cease criterion (i.e., the first cease condition or the second cease condition) of the iteration is configured by the CPU. In some example embodiments, the cease criterion of the iteration is based on deterministic configuration of the network. As one example, the cease criterion can be configured by the CPU to be a threshold number of iterations according to a historical statistic.

Alternatively, in some example embodiments, the cease criterion of the iteration is based on dynamic measurements at each AP and/or terminal device. As one example, whether to cease the iteration may be determined based on the measurement results at AP, for example, each AP can measure the effective beamforming gain according to below equation (3).

$${G}_{m} ( i ) = 𝔼 \{ {‖ {W}_{k}^{H} ( i ) {HF}_{m} ( i ) ‖}_{F}^{2} \} \qquad ( 3 )$$

Each AP further determines a beamforming gain difference by below equation (4).

$${d}_{{G}_{m}} = \vert {G}_{m} ( i ) - {G}_{m} ( i - 1 ) \vert \qquad ( 4 )$$

Each AP may determine to cease the iteration if the beamforming gain difference is smaller than a threshold difference.

Alternatively, whether to cease the iteration may be determined by the CPU. As one example, each AP transmits the beamforming gain difference to the CPU. After collecting all the beamforming gain differences from M APs, the CPU determines whether Σₘd_{G}_{ₘ}<ϵ, where ϵ is a convergence threshold. If yes, the CPU may determine to cease the iteration.

It is to be understood that whether to cease the iteration also may be determined based on the measurement results at terminal device. Merely for brevity, similar contents are omitted here.

In some embodiments, it is unnecessary to sweep all beams at each iteration. In one specific example embodiments, measuring the received pilots maybe carried out by sweeping over all the beams in the original beam sweeping, where the pilots may be transmitted via wide beams. In the following beam sweepings, either the terminal device or AP already know a general angular coverage, and subsequent beam alignment using narrow beams will be carried out within the general angular coverage.

Next, the terminal devices and the APs may perform 330 transmission with each other (including data, RS and so on).

### Examples when the First Deices 110 (i.e., the Initiators) are the Terminal Devices

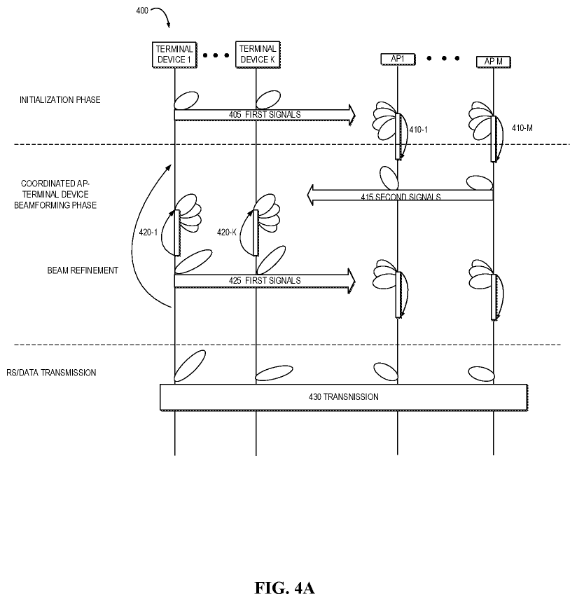

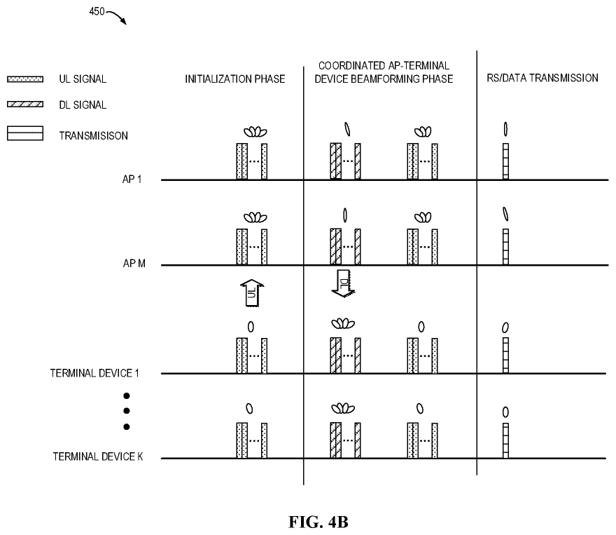

Example embodiments of the present disclosure will be described in detail below with reference to FIG. 4A and FIG. 4B, where FIG. 4A shows a further signaling flow 400 for communication according to some example embodiments of the present disclosure, and FIG. 4B shows another transmission timing 450 according to some example embodiments of the present disclosure. The signaling flow 400 and transmission timing 450 include AP 1, . . . . AP m, . . . , AP M and terminal device 1 to terminal device K.

As illustrated in FIG. 4A, during initialization phase, terminal devices (the terminal device 1 to terminal devoice K) simultaneously transmit 405 first signals (such as, UL pilots, SRS)) via the initialized terminal device-dedicated common beam(s) m (i.e., the first beam).

In some example embodiments, the simultaneous transmission from the terminal devices is scheduled by the CPU (i.e., the third device). In one specific embodiments, the CPU schedules transmission resource and transmit timing for the first signals (i.e., SRS).

In some example embodiments, the initialized terminal device-dedicated common beam(s) is (are) determined at each terminal device. In one specific example embodiment, the initialized terminal device-dedicated common beam(s) may be initialized as direct combining, for example,

$${W}_{k} ( 0 ) = {\vert {I}_{{N}_{r}}^{T} , {0}_{{M}_{r} - {N}_{r} , {N}_{r}}^{T} \vert}^{T} ,$$

where Mᵣ, Nᵣ denote the numbers of combining, for example, antenna elements and RF chains at each terminal device, respectively. In some other example embodiments, the initialized terminal device-dedicated common beam(s) may be determined to be other default beams.

Alternatively, in some example embodiments, the random DFT based beam can be used for initializing the initialized terminal device-dedicated common beam(s). For DFT initialization beam, Wₖ(0)=C_{DFT}(i)∈C^{M}^{ᵣ}^{×N}^{ᵣ}, where C_{DFT}(i) is the Nᵣ beam vectors randomly selected from the DFT codebook. Additionally, in some example embodiments, if a rough angle of interest can be obtained, the initialized terminal device-dedicated common beam(s) may be chosen based on this knowledge.

In some example embodiments, each AP selects the AP-dedicated common beam(s) (i.e., the second beam) which is (are) optima to all serving terminal devices, i.e., the AP 1 determines 410-1 its respective second beam and the AP M determines 410-M its respective second beam accordingly

In one specific example embodiments, the AP-dedicated common beam

$${F}_{m}^{( c )}$$

can be obtained by using beam sweeping to solve the optimization problem in above equation (2).

As shown in FIG. 4A, APs apply their own AP-dedicated common beams and simultaneously transmit 415 the second signals (such as, DL pilots, CSI-RS) to their serving terminal devices. The terminal devices receive the second signals and measure the received second signals.

In some example embodiments, each terminal device selects the terminal device-dedicated common beam(s) (i.e., an updated first beam) which is (are) optima to all serving APs. In one specific example embodiments, the terminal device-dedicated common beam(s) can be obtained by using beam sweeping to solve the optimization problem in above equation (1).

In some example embodiments, iteration may be used for further aligning the AP-dedicated common beams and terminal device-dedicated common beams. As shown in FIG. 4A, operations of at 410-1, 410-K, 415, 420-1, 420-M and 425 may be performed iteratively. In some example embodiments, the cease criterion (i.e., the first cease condition or the second cease condition) of the iteration is configured by the CPU. The configuration of the cease criterion is similar with that discussed for the example scenarios where the initiators are the APs. Merely for brevity, similar contents are omitted here.

Next, the terminal devices and the APs may perform 430 transmission with each other (including data, RS and so on).

### Simulation Results

In the following, the performance of the present disclosure for the beamforming function is evaluated in the by comparing the present disclosure the small-cell scheme using multi-antenna/hybrid-array terminal devices in the mmWave distributed/cell-free massive MIMO systems. For the small-cell scheme, each terminal device is served by only one AP and the available AP is chosen based on the best channel quality. If one AP has already been selected by other terminal device, the next available AP with the second best channel quality will be chosen. APs that are not selected will be inactive.

In addition, the mm Wave channels are modeled at 28 GHz, where each channel link could be one of the three states, i.e., line-of-sight, non-line-of-sight, and outage. The probability calculation for distance d follows pₒᵤₜ(d)=max{0, 1−e⁻^{ₒᵤₜ}^{d+b}^{ₒᵤₜ}}, p_{LOS}(d)=[1−pₒᵤₜ(d)]e^{-a}^{_{LOS}}^{d} p_{NLOS}=1−pₒᵤₜ(d)−p_{LOS}(d), respectively. The large-scale propagation parameters are shown in below Table 1.

TABLE 1
Simulation parameters of the channel model

| Parameters | Values |
|---|---|
| Carrier Frequency | 28 GHZ |
| Pathloss at distance d m | NLOS: α = 72, β = 2.92 |
| PL = α + 10β log₁₀(d) + ξ [dB] | LOS: α = 61.4, β = 2 |
| Lognomal shadowing ξ~(0, σ²) | NLOS: σ = 8.7 GB |
| | LOS: σ = 5.8 dB |
| NLOS-LOS-Outage | $\frac{1}{{a}_{out}} = 30 m , {b}_{out} = 5.2 \\ \frac{1}{{a}_{LOS}} = 67.1 m$ |

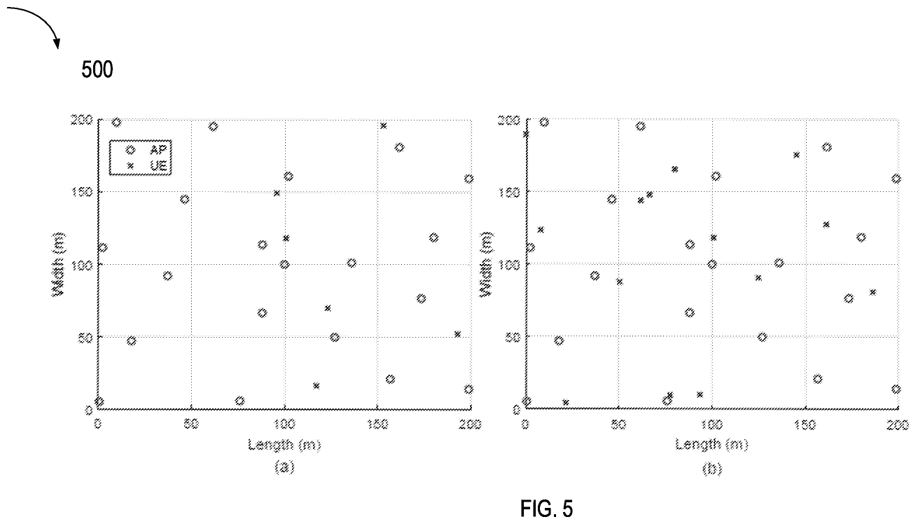

Further, the simulated model relates M=20 APs which are uniformly distributed within a square area of dimension 200 m×200 m and the minimum separation between any two APs is set as 40 m. terminal devices are also randomly distributed in this area, as shown in FIG. 5, which illustrates examples of the AP and terminal device distribution 500 within the considered area. The fixed AP distribution and 1000 realizations of random terminal device positions are considered in the simulation. Each AP has a uniform rectangular array (URA) of size 4×8 and fully-connected to 4 RF chains. The average transmit power at each AP is 250 mW and the noise power spectral density at terminal device is −162 dBm.

Two cases for terminal device configurations are simulated. When terminal device has two antennas Mr=2, i.e., fully digital receiver, it corresponds to the special case when no analog beam alignment is required. When each terminal device has a hybrid array, i.e., URA of 2×4 with 8 antenna elements (Mr=8) and 2 RF chains, it applies the proposed analog beam alignment to enhance the beamforming gain of the system.

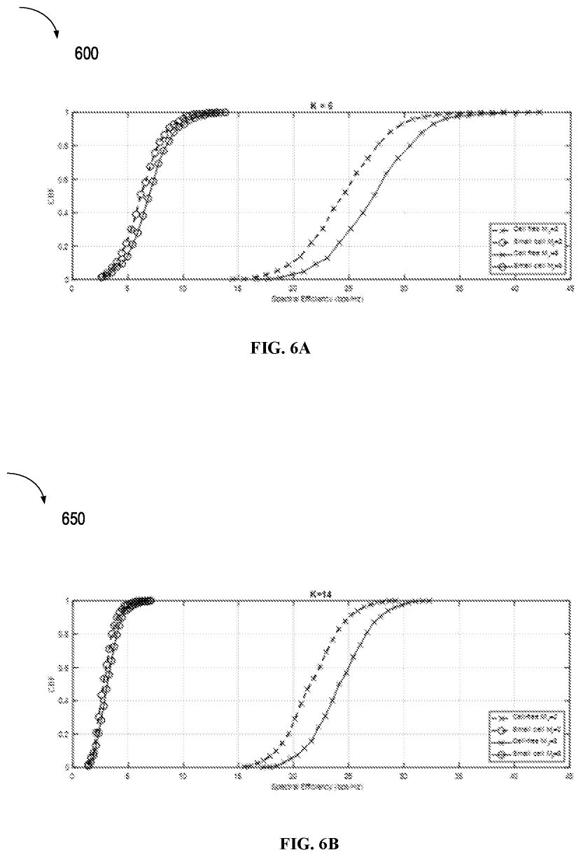

FIG. 6A and FIG. 6B illustrates the spectral efficiency performances 600 and 650 of the proposed analog beam alignment procedure in distributed/cell-free MIMO as compared to a small cell scheme, considering various number of terminal devices. It can be observed that in general the cell-free scheme significantly outperforms the small cell counterpart at both the median and 5% levels, by 5~8 times and 5~10 times, respectively. It also shows that using the proposed analog beam alignment (Mr=8), an enhanced performance is obtained at terminal device (Mr=2) as compared to the no-analog-beam case, especially in distributed/cell-free systems.

Therefore, it shows a great potential of using the cell-free concept at mm Wave with hybrid-array terminal devices and the proposed analog beam alignment mechanism could bring a satisfying performance as compared to the small-cell scheme.

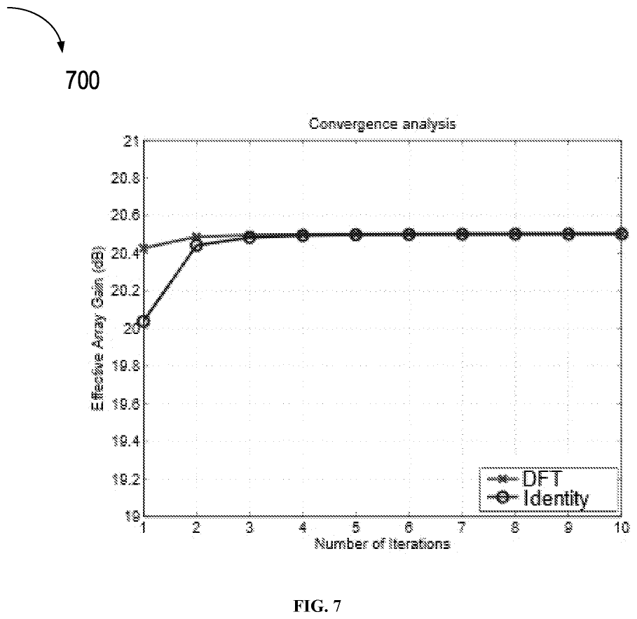

The convergence performance using iterations is also evaluated. FIG. 7 illustrates convergence performance 700 of the proposed beam alignment procedure versus the number of iterations, where two beam initialization schemes are considered, identity beam or random DFT beam. Using random DFT beam space beam (can be wide beam covering a large angular region, no need to know the angular information a priori) as an initialization beam only requires maximal 2 iterations. If an identity beamforming matrix (worst case) is used, 3 iterations is needed to achieve convergence.

In some cases, beam management procedure requires procedures including transmit beam sweeping and receive beam sweeping; ii. the refined selection of transmit beam sweeping. This latency of the beam management procedure has the latency equivalent to 2 iterations.

In summary, according to some embodiments, distributed beamforming and system architecture for distributed MIMO is supported, comparing with to the co-located massive MIMO, the antenna array of a smaller size and power consumption at each AP in the distributed MIMO is enabled. Further, multi-panel terminal device with multi-beam transmission and reception capability is enabled, which enhances the link reliability. In addition, the maximization of the total effective array gain between all AP to all terminal devices, approaching the fully digital performance. Moreover, it does not increase the number of RF chains, i.e., there is no constraint on the number of RF chains at AP side, since one beam (at least one) that is good to all terminal devices may be find. Due to the criterion of maximizing total effective array gain and iterative procedure enables the maximization problem easily.

The present disclosure differs from the technology of non-coherent joint transmission (NCJT). Specifically, in the solution of the present disclosure, multi-AP/UE simultaneous transmission of the pilots via predefined/selected beam and triggering the multi-UE/AP simultaneous measurements of receive pilots and no transmission and reception point (TRP) transmit beam sweeping and terminal device beam feedback procedure is considered.

### Example Methods

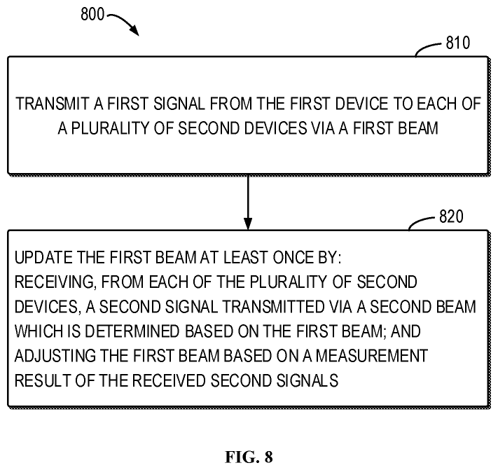

FIG. 8 shows a flowchart of an example method 800 implemented at a first device in accordance with some example embodiments of the present disclosure. For the purpose of discussion, the method 800 will be described from the perspective of the first device 110 in FIG. 1.

At block 810, the first device 110 transmits a first signal from the first device 110 to each of a plurality of second devices 120 via a first beam.

At block 820, the first device 110 updates the first beam at least once by: receiving, from each of the plurality of second devices 120, a second signal transmitted via a second beam which is determined based on the first beam; and adjusting the first beam based on a measurement result of the received second signals.

In some example embodiments, the first beam is initially determined as a wide beam.

In some example embodiments, the first beam is initially determined as a predetermined beam, or a randomly obtained beam.

In some example embodiments, at least one of the following is periodical: the first signal or the second signal.

In some example embodiments, the first device 110 receives the second signals from the plurality of second devices 120 simultaneously.

In some example embodiments, the first device 110 adjusts the first beam to increase a beamforming gain at the first device 110 with respect to the plurality of second devices 120.

In some example embodiments, the first device 110 adjusts the first beam to a beam that enables a maximum beamforming gain at the first device 110 with respect to the plurality of second devices 120.

In some example embodiments, the first device 110 receives a configuration generated by a third device 130 and related to at least one of the following: the first signal or the second signal.

In some example embodiments, the configuration indicates a transmission resource. Alternatively, in some example embodiments, the configuration indicates a timing for transmission. Alternatively, in some example embodiments, the configuration indicates a periodicity for transmission. Alternatively, in some example embodiments, the configuration indicates an indication for transmission.

In some example embodiments, if the first device 110 is a network device and the first device 110 further transmits the configuration to the second devices 120.

In some example embodiments, the first device 110 iteratively updates the first beam until a first cease condition is met.

In some example embodiments, the first cease condition is related to the number of iterations. Alternatively, in some example embodiments, the first cease condition is related to a beamforming gain of the first beam at the first device 110. Alternatively, in some example embodiments, the first cease condition is related to a beamforming gain difference between two adjacent iterations. Alternatively, in some example embodiments, the first cease condition is related to an indication to cease iteration.

In some example embodiments, the first device 110 receives information on the first cease condition determined by a third device 130.

In some example embodiments, the first device 110 receives the second signals by beam sweeping, wherein the number of beams in the beam sweeping decreases as the number of iterations increases.

In some example embodiments, the first and second signals are reference signals.

In some example embodiments, the first device 110 is a network device, and the plurality of second devices 120 are terminal devices, or the first device 110 is a terminal device, and the plurality of second devices 120 are network devices.

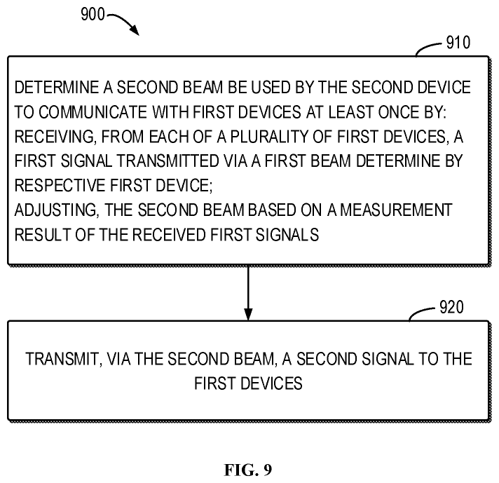

FIG. 9 shows a flowchart of an example method 900 implemented at a first device in accordance with some example embodiments of the present disclosure. For the purpose of discussion, the method 900 will be described from the perspective of the second device 120 in FIG. 1.

At block 910, the second device 120 determines a second beam be used by the second device 120 to communicate with first device 110s at least once by: receiving, from each of a plurality of first devices 110, a first signal transmitted via a first beam determine by respective first device 110; and adjusting, the second beam based on a measurement result of the received first signals.

At block 920, the second device 120 transmits, via the second beam, a second signal to the first devices 110.

In some example embodiments, at least one of the following is periodical: the first signal or the second signal.

In some example embodiments, the second device 120 receives the first signals from the plurality of first devices 110 simultaneously.

In some example embodiments, the second device 120 adjusts the second beam to increase a beamforming gain at the second device 120 with respect to the plurality of first devices 110.

In some example embodiments, the second device 120 adjusts the second beam to a beam that enables a maximum beamformer gain at the second device 120 with respect to the plurality of first devices 110.

In some example embodiments, the second device 120 receives a configuration generated by a third device 130 and related to at least one of the following: the first signal or the second signal.

In some example embodiments, the configuration indicates a transmission resource.

Alternatively, in some example embodiments, the configuration indicates a timing for transmission.

Alternatively, in some example embodiments, the configuration indicates a periodicity for transmission.

Alternatively, in some example embodiments, the configuration indicates an indication for transmission.

In some example embodiments, if the second device 120 is a network device, the second device 120 further transmits the configuration to the first device 110.

In some example embodiments, the second device 120 iteratively determines the second beam until a second cease condition is met.

In some example embodiments, the second cease condition is related to the number of iterations.

Alternatively, in some example embodiments, the second cease condition is related to a beamforming gain of the second beam at the second device 120.

Alternatively, in some example embodiments, the second cease condition is related to a beamforming gain difference between two adjacent iterations.

Alternatively, in some example embodiments, the second cease condition is related to an indication to cease iteration.

In some example embodiments, the second device 120 receives information on the second cease condition determined by a third device 130.

In some example embodiments, the second device 120 receives the first signals by beam sweeping, wherein the number of beams in the beam sweeping decreases as the number of iterations increases.

In some example embodiments, the first and second signals are reference signals.

In some example embodiments, the second device 120 is a network device, and the plurality of first devices 110 are terminal devices, or the second device 120 is a terminal device, and the plurality of first devices 110 are network devices.

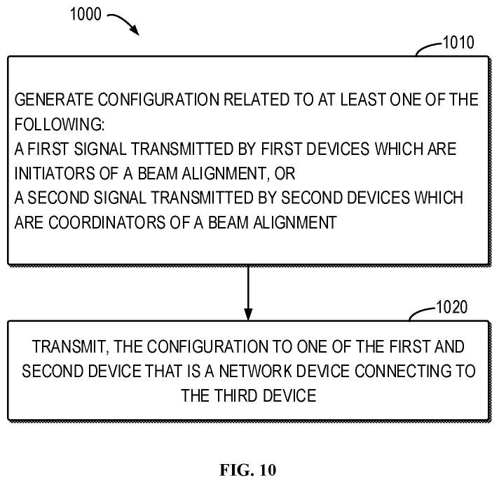

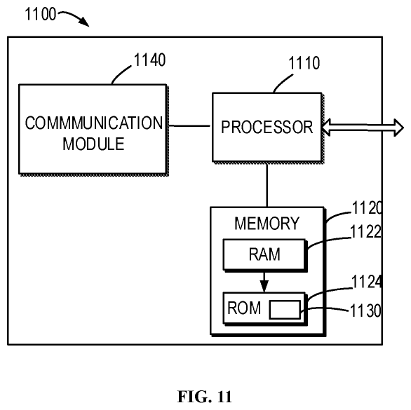

FIG. 10 shows a flowchart of an example method 1000 implemented at a first device in accordance with some example embodiments of the present disclosure. For the purpose of discussion, the method 1000 will be described from the perspective of the third device 130 in FIG. 1.

At block 1010, the third device 130 generates a configuration related to a first signal transmitted by first devices 110 which are initiators of a beam alignment, or a second signal transmitted by second devices 120 which are coordinators of a beam alignment.

At block 1010, the third device 130 transmits, the configuration to one of the first and second device 120 that is a network device connecting to the third device 130.

In some example embodiments, the configuration indicates a transmission resource.

Alternatively, in some example embodiments, the configuration indicates a timing for transmission.

Alternatively, in some example embodiments, the configuration indicates a periodicity for transmission.

Alternatively, in some example embodiments, the configuration indicates an indication for transmission.

In some example embodiments, the third device 130 transmits at least one of the following to one of the first and second device 120 that is a network device connecting to the third device 130: information on the first cease condition to be used by the first devices 110 for determining whether to cease the beam alignment, or information on the second cease condition to be used by the second devices 120 for determining whether to cease the beam alignment.

In some example embodiments, the third device 130 is a central processing device, and wherein the first devices 110 are network devices and the second devices 120 are terminal devices, or the first devices 110 are terminal devices and the second devices 120 are network devices.

### Example Apparatus, Device and Medium

In some example embodiments, a first apparatus capable of performing any of the method 800 (for example, the first device 110 in FIG. 1) may comprise means for performing the respective operations of the method 800. The means may be implemented in any suitable form. For example, the means may be implemented in a circuitry or software module. The first apparatus may be implemented as or included in the first device 110 in FIG. 1.

In some example embodiments, the first apparatus comprises means for transmitting a first signal from the first apparatus to each of a plurality of second apparatuses via a first beam; means for updating the first beam at least once by: receiving, from each of the plurality of second apparatuses, a second signal transmitted via a second beam which is determined based on the first beam; and adjusting the first beam based on a measurement result of the received second signals.

In some example embodiments, the first beam is initially determined as a wide beam.

In some example embodiments, the first beam is initially determined as a predetermined beam, or a randomly obtained beam.

In some example embodiments, at least one of the following is periodical: the first signal or the second signal.

In some example embodiments, the first apparatus comprises means for receiving the second signals from the plurality of second apparatuses simultaneously.

In some example embodiments, the first apparatus comprises means for adjusting the first beam to increase a beamforming gain at the first apparatus with respect to the plurality of second apparatuses.

In some example embodiments, the first apparatus comprises means for adjusting the first beam to a beam that enables a maximum beamformer gain at the first apparatus with respect to the plurality of second apparatuses.

In some example embodiments, the first apparatus further comprises means for receiving a configuration generated by a third apparatus and related to at least one of the following: the first signal or the second signal.

In some example embodiments, the configuration indicates a transmission resource. Alternatively, in some example embodiments, the configuration indicates a timing for transmission. Alternatively, in some example embodiments, the configuration indicates a periodicity for transmission. Alternatively, in some example embodiments, the configuration indicates an indication for transmission.

In some example embodiments, if the first apparatus is a network apparatus, the first apparatus further comprises means for transmitting the configuration to the second apparatuses.

In some example embodiments, the first apparatus further comprises means for iteratively updating the first beam until a first cease condition is met.

In some example embodiments, the first cease condition is related to the number of iterations. Alternatively, in some example embodiments, the first cease condition is related to a beamforming gain of the first beam at the first apparatus. Alternatively, in some example embodiments, the first cease condition is related to a beamforming gain difference between two adjacent iterations. Alternatively, in some example embodiments, the first cease condition is related to an indication to cease iteration.

In some example embodiments, the first apparatus further comprises means for receiving information on the first cease condition determined by a third apparatus.

In some example embodiments, the first apparatus receives the second signals by beam sweeping, wherein the number of beams in the beam sweeping decreases as the number of iterations increases.

In some example embodiments, the first and second signals are reference signals.

In some example embodiments, the first apparatus is a network apparatus, and the plurality of second apparatuses are terminal apparatuses, or the first apparatus is a terminal apparatus, and the plurality of second apparatuses are network apparatuses.

In some example embodiments, a second apparatus capable of performing any of the method 900 (for example, the first device 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for determining a second beam be used by the second apparatus to communicate with first apparatuses at least once by: receiving, from each of a plurality of first apparatuses, a first signal transmitted via a first beam determine by respective first apparatus; and adjusting, the second beam based on a measurement result of the received first signals.; and means for transmitting, via the second beam, a second signal to the first apparatuses.

In some example embodiments, at least one of the following is periodical: the first signal or the second signal.

In some example embodiments, the second apparatus receives the first signals from the plurality of first apparatuses simultaneously.

In some example embodiments, the second apparatus comprises means for adjusting the second beam to increase a beamforming gain at the second apparatus with respect to the plurality of first apparatuses.

In some example embodiments, the second apparatus comprises means for adjusting the second beam to a beam that enables a maximum beamforming gain at the second apparatus with respect to the plurality of first apparatuses.

In some example embodiments, the second apparatus further comprises means for receiving a configuration generated by a third apparatus and related to at least one of the following: the first signal or the second signal.

In some example embodiments, the configuration indicates a transmission resource.

Alternatively, in some example embodiments, the configuration indicates a timing for transmission.

Alternatively, in some example embodiments, the configuration indicates a periodicity for transmission.

Alternatively, in some example embodiments, the configuration indicates an indication for transmission.

In some example embodiments, if the second apparatus is a network apparatus, the second apparatus further transmits the configuration to the first apparatus.

In some example embodiments, the second apparatus iteratively determines the second beam until a second cease condition is met.

In some example embodiments, the second cease condition is related to the number of iterations.

Alternatively, in some example embodiments, the second cease condition is related to a beamforming gain of the second beam at the second apparatus.

Alternatively, in some example embodiments, the second cease condition is related to a beamforming gain difference between two adjacent iterations.

Alternatively, in some example embodiments, the second cease condition is related to an indication to cease iteration.

In some example embodiments, the second apparatus further comprises means for receiving information on the second cease condition determined by a third apparatus.

In some example embodiments, the second apparatus receives the first signals by beam sweeping, wherein the number of beams in the beam sweeping decreases as the number of iterations increases.

In some example embodiments, the first and second signals are reference signals.

In some example embodiments, the second apparatus is a network apparatus, and the plurality of first apparatuses are terminal apparatuses, or the second apparatus is a terminal apparatus, and the plurality of first apparatuses are network apparatuses.

In some example embodiments, a third apparatus capable of performing any of the method 1000 (for example, the first device 130 in FIG. 1) may comprise means for performing the respective operations of the method 1000. The means may be implemented in any suitable form. For example, the means may be implemented in a circuitry or software module. The third apparatus may be implemented as or included in the third device 130 in FIG. 1.

In some example embodiments, the third apparatus comprises means for generating a configuration related to a first signal transmitted by first apparatuses which are initiators of a beam alignment, or a second signal transmitted by second apparatuses which are coordinators of a beam alignment; and means for transmitting, the configuration to one of the first and second apparatus that is a network apparatus connecting to the third apparatus.

In some example embodiments, the configuration indicates a transmission resource.

Alternatively, in some example embodiments, the configuration indicates a timing for transmission.

Alternatively, in some example embodiments, the configuration indicates a periodicity for transmission.

Alternatively, in some example embodiments, the configuration indicates an indication for transmission.

In some example embodiments, the third apparatus transmits at least one of the following to one of the first and second apparatus that is a network apparatus connecting to the third apparatus: information on the first cease condition to be used by the first apparatuses for determining whether to cease the beam alignment, or information on the second cease condition to be used by the second apparatuses for determining whether to cease the beam alignment.

In some example embodiments, the third apparatus is a central processing apparatus, and wherein the first apparatuses are network apparatuses and the second apparatuses are terminal apparatuses, or the first apparatuses are terminal apparatuses and the second apparatuses are network apparatuses.

FIG. 11 is a simplified block diagram of a device 1100 that is suitable for implementing example embodiments of the present disclosure. The device 1100 may be provided to implement a communication device, for example, the first device 110, second device 120 or the third device 130 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The instructions of the program 1130 may include instructions for performing operations/acts of some example embodiments of the present disclosure. The program 1130 may be stored in the memory, e.g., the ROM 1124. The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIG. 2 to FIG. 10. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

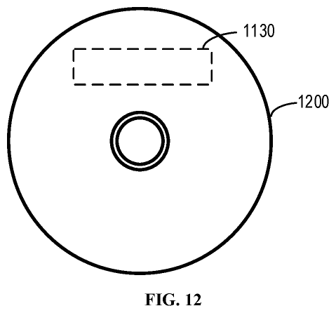

FIG. 12 shows an example of the computer readable medium 1110 which may be in form of CD, DVD or other optical storage disk. The computer readable medium 1110 has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory storing instructions that, when executed with the at least one processor, cause the first device at least to perform:
transmitting a first signal from the first device to a plurality of second devices with a first beam;
updating the first beam at least once with:
receiving, from the plurality of second devices, a second signal transmitted with a second beam which is determined based on the first beam; and
adjusting the first beam based on a measurement result of the received second signals.

2. The first device of claim 1, wherein the instructions, when executed with the at least one processor, cause the first device to initially determine the first beam as a wide beam.

3. The first device of claim 1, wherein the instructions, when executed with the at least one processor, cause the first device to initially determine the first beam as a predetermined beam or a randomly obtained beam.

4. The first device of claim 1, wherein at least one of the following is periodical: the first signal or the second signal.

5. The first device of claim 1, wherein the instructions, when executed with the at least one processor, cause the first device to receive the second signals from the plurality of second devices simultaneously.

6. The first device of claim 1, wherein the instructions, when executed with the at least one processor, cause the first device to adjust the first beam to increase a beamforming gain at the first device with respect to the plurality of second devices.

7. (canceled)

8. The first device of claim 1, wherein the instructions, when executed with the at least one processor, cause the first device to perform:
receiving a configuration generated with a third device and related to at least one of the following: the first signal or the second signal.

9. The first device of claim 8, wherein the configuration indicates at least one of the following:
a transmission resource,
a timing for transmission,
a periodicity for transmission, or
an indication for transmission.

10. (canceled)

11. The first device of claim 1, wherein the instructions, when executed with the at least one processor, cause the first device to iteratively update the first beam until a first cease condition is met.

12. The first device of claim 11, wherein the first cease condition is related to at least one of the following:
a number of iterations,
a beamforming gain of the first beam at the first device,
a beamforming gain difference between two adjacent iterations, or
an indication to cease iteration.

13-16. (canceled)

17. A second device, comprising:
at least one processor; and
at least one memory storing instructions that, when executed with the at least one processor, cause the second device at least to perform:
determining a second beam be used with the second device to communicate with a plurality of first devices at least once with:
receiving, from the plurality of first devices, a first signal transmitted with a first beam determined with the respective first device;
adjusting, the second beam based on a measurement result of the received first signals; and
transmitting, with the second beam, a second signal to the plurality of first devices.

18. The second device of claim 17, wherein at least one of the following is periodical: the first signal or the second signal.

19. The second device of claim 17, wherein the instructions, when executed with the at least one processor, cause the second device to receive the first signals from the plurality of first devices simultaneously.

20. The second device of claim 17, wherein the instructions, when executed with the at least one processor, cause the second device to adjust the second beam to increase a beamforming gain at the second device with respect to the plurality of first devices.

21. The second device of claim 17, wherein the instructions, when executed with the at least one processor, cause the second device to adjust the second beam to a beam that enables a maximum beamforming gain at the second device with respect to the plurality of first devices.

22. The second device of claim 17, wherein the instructions, when executed with the at least one processor, cause the second device to perform:
receiving a configuration generated with a third device and related to at least one of the following: the first signal or the second signal.

23-30. (canceled)

31. A third device, comprising:
at least one processor; and
at least one memory storing instructions that, when executed with the at least one processor, cause the third device at least to perform:
generating a configuration related to at least one of the following:
a first signal transmitted with a plurality of first devices which are initiators of a beam alignment, or
a second signal transmitted with a plurality of second devices which are coordinators of a beam alignment; and
transmitting, the configuration to one of the first or second device that is a network device connecting to the third device.

32. The third device of claim 31, wherein the configuration indicates at least one of the following:
a transmission resource,
a timing for transmission,
a periodicity for transmission, or
an indication for transmission.

33. The third device of claim 31, wherein the instructions, when executed with the at least one processor, cause the third device to perform:
transmitting at least one of the following to one of the first or second device that is a network device connecting to the third device:
information on the first cease condition to be used with the first devices for determining whether to cease the beam alignment, or
information on the second cease condition to be used with the second devices for determining whether to cease the beam alignment.

34. The third device of claim 31, wherein the third device is a central processing device, and wherein the first devices are network devices and the second devices are terminal devices, or the first devices are terminal devices and the second devices are network devices.

35-72. (canceled)
